(19) United States
(12) Patent Application Publication
(10) Pub. No.: US 2015/0220197 A1
(43) Pub. Date: Aug. 6, 2015

(54) 3D FORCE SENSOR FOR INTERNET OF THINGS

(71) Applicant: Cherif Algreatly, Newark, CA (US)

(72) Inventor: Cherif Algreatly, Newark, CA (US)

(73) Assignee: Cherif Atia Algreatly, Newark, CA (US)

(21) Appl. No.: 14/179,430

(22) Filed: Feb. 12, 2014

Related U.S. Application Data
(63) Continuation-in-part of application No. 14/169,822, filed on Jan. 31, 2014, now abandoned.

(51) Int. Cl. G06F 3/041; G06F 3/0481

(52) U.S. Cl. CPC G06F 3/0414; G06F 3/0416; G06F 3/04815

(57) ABSTRACT

Disclosed is a 3D force sensor that can detect its orientation and the magnitude and 3D direction of a force applied to its surface. The force can be non-parallel and non-orthogonal to the surface of the 3D force sensor. A plurality of the 3D force sensors are simultaneously used to detect the orientation of an object and the magnitude and 3D direction of the forces applied to the object. Also, a plurality of the 3D force sensor can be used to detect the tilting of a vertical or horizontal stacking of a plurality of objects relative to one another.

### CROSS-REFERENCE TO RELATED APPLICATION

This application is a continuation-in-part of U.S. patent application Ser. No. 12/587,339, filed Oct. 6, 2009, titled “Touch Sensing Technology”, and Ser. No. 14/169,822, filed 31 Jan., 2014, titled “Force Sensing Touchscreen”.

### BACKGROUND

Force sensors are used in various applications to measure the magnitude of an orthogonal force applied to one side of a surface. It is easy to imagine the unlimited number of applications which can be developed with force sensors. For example, force sensors are used in various computer input devices, like touchpads, computer mouses, and gaming controllers, to provide the computer system with an immediate input representing the magnitude of a force or pressure. This magnitude of force may be used to represent the speed of movement in a gaming application, the depth of a third dimension in a 3D application, the size or color transparency of an object in a graphics application, and other such things.

In robotics, force sensors are utilized in grasping and manipulating a robot hand while carrying an object. In the automotive industry, force sensors are used to measure the force generated by an object, such as a tire, boot, or a ski movement. In medical applications, force sensors are used to measure the force applied by a human body to a pair of shoes, seat, bed, or the like, for the purpose of analyzing or assessing a user's posture or walking and sitting behaviors. In sports, force sensors are used in golf clubs, tennis rockets, and baseball bats to detect the forces applied to these items during training or a game. In addition to, other limitless uses and applications in the industrial, manufacturing, and engineering fields.

Generally, all commercially available force sensors measure the magnitude of a force applied to a surface, but none of them measure the 3D tilting angle of the force when the force is non-parallel and non-orthogonal to the surface. In fact, it is incredibly important to detect the 3D tilting angle of a force, as this information can be utilized in various crucial applications. For example, in a gaming application, if the magnitude of a force represents a speed of a movement, the 3D titling angle of the force can represent the direction of the movement in three-dimensions on the computer display. In robotics, if the magnitude of a force represents a weight of an object carried by a robot hand, the 3D tilting angle of the force can represent the vertical direction or the balance of the object on the robot hand. In mechanics, if the magnitude of a force represents a compaction between two objects contacting each other, the 3D tilting angle of the force can represent the angle between the two objects at the moment of contact or compaction. In medical applications, if a force exerted by a patient's leg on a shoe represents a partial weight of the patient on the shoe, the 3D tilting angle of the force can represent the 3D direction of the leg structure when the patient is walking or standing. These are minor examples of many practical applications that can utilize the detection of the 3D tilting angle of a force applied to a surface, as will be described subsequently.

There is a need for new types of force sensors that simultaneously measure the magnitude and 3D tilting angle of a force applied to a surface. These new types of force sensors are to serve the current and future applications of the computer, robotics, automotive, medical, industrial, and manufacturing fields, in addition to, the Internet of things.

### SUMMARY

In one embodiment, the present invention discloses a 3D force sensor that is able to simultaneously sense the magnitude of a force and the 3D tilting angle of the force when touching the force sensor. The force can be applied to the 3D force sensor from different sides or directions. For example, the force may be applied to the top, bottom, left, right, front, or back sides of the 3D force sensor. The force can be non-parallel and non-orthogonal to any surfaces or sides of the 3D force sensor. If multiple forces are simultaneously applied to different sides of the 3D force sensor, then the centroid and resultant of the multiple forces are determined.

In another embodiment, a plurality of 3D force sensors are simultaneously utilized to sense the magnitude and 3D tilting angle of the force applied to a 3D object. Each sensor of the plurality of the 3D force sensors is a wireless sensor that can be attached to the 3D object at a position to generate a signal. The signals of the plurality of the 3D force sensors represent the magnitude and 3D tilting angle of all forces applied to the 3D object. If the 3D object is tilted or rotated relative to its original position, the signal of the plurality of 3D force sensors indicates an accurate description for the tilting or rotation of the 3D object. This use of the present invention opens the door for an unlimited number of innovative applications that can enhance various fields, as will be described subsequently.

In one example of a computer application, it is possible to convert the surface of an object into a touchscreen that detects the point of touch, as well as, the magnitude and 3D tilting angle of the touch force. The object can be a vase, statue, bottle, frame, or the like that is made from a variety of materials, such as wood, plastic, or glass. Another use the present invention can provide is the ability to turn an entire computer (including the keyboard, screen and case) into a touchscreen, where touching any part of the computer provides an immediate input to the computer system, representing the point of touch, and the magnitude and 3D tilting angle of the touch force.

In another computer application, it is possible to turn a sort of musical instrument imitator (for example, a printed piano or drum set) into a vividly working musical instrument using a plurality of the 3D force sensors of the present invention. This is achieved by detecting the exact hand or finger interactions associated with the musical instrument imitator, after which, these are translated into corresponding musical sounds, abiding to the nature of the desired musical instrument, in real time. Also this system is capable of responding even to blown air (for instance, playing an otherwise nonfunctioning trumpet replication).

Generally, the aforementioned examples of the present invention are only for computer applications, while other innovative examples and applications for other fields will be described subsequently. However, the above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example of a touching cube where each face of the touching cube touches a sensor.

FIG. 2 illustrates positioning four sensors on each face of the six faces of the touching cube

FIG. 3 illustrates positioning an optical sensor at each corner of the touching cube to detect the movement of the corner relative to the x, y, and z-axis.

FIG. 4 illustrates a top view of the touching cube where four cameras are tracking the top four corners of the touching cube.

FIG. 5 illustrates a front view of the touching cube where four cameras are tracking the front four corners of the touching cube.

FIGS. 6 and 7 illustrate the location of a maker relative to the center of a camera lens where the marker is positioned at a corner of a touching cube.

FIGS. 8 to 12 illustrate the movement of the marker, with the touching cube movement, when a force touches a face of the touching cube.

FIG. 13 illustrates an example of a panel where a force sensor is positioned at each bottom corner of the panel, in an oblique position relative to the panel surface and edges.

FIGS. 14 and 15 illustrate an example of a 3D force sensor according to one embodiment of the present invention.

FIGS. 16 to 20 illustrate the use of ON/OFF buttons to detect a force applied to a surface, according to one embodiment of the present invention.

FIGS. 21 and 22 illustrate two tables presenting the accuracy of detecting the direction of movement of a touching panel when using two different numbers of ON/OFF buttons.

FIGS. 23 and 24 illustrate positioning a plurality of sensors on each face of a touching cube to detect the point of touch, and the magnitude and 3D tilting angle of a force applied to any face of the touching cube.

FIG. 25 illustrates a plurality of sensors positioned in circular layers at each corner of a touching cube, according to one embodiment of the present invention.

FIG. 26 illustrates two layers of sensors positioned in a circular configuration, according to one embodiment of the present invention.

FIG. 27 illustrates three layers of sensors positioned in a circular configuration, according to one embodiment of the present invention.

FIG. 28 illustrates the configuration of the main parts of the 3D force sensor of the present invention.

FIGS. 29 to 31 illustrate detecting the tilting of the 3D force sensor by the sensors located inside the 3D force sensor.

FIG. 32 illustrates detecting the tilting of a 3D force sensor relative to the xy-plane, when the 3D force sensor is positioned on one of its corner on a surface.

FIGS. 33 to 41 illustrate using the present invention with various objects such as a vase, piano keyboard, computer keyboard, computer mouse, laptop computer, statue, or the like to detect the point of touch between the user's finger and these objects.

FIGS. 42 to 44 illustrates using the 3D force sensors of the present invention to detect the alignment or tilting of a plurality of objects stacked vertically and horizontally relative to each other.

### DETAILED DESCRIPTION

The U.S. patent application Ser. No. 12/587,339 discloses a device that detects the three-dimensional direction and magnitude of a force applied by an object to a surface. The device is comprised of a touching cube and six sensors. The touching cube has six faces wherein each face of the six faces is a surface that can be touched by the object to move the touching cube in three simultaneous directions relative to the x, y, and z-axis. Each one of the six sensors is in touch with one face of the touching cube, to detect the value of the force exerted on the one face, wherein the value of the force exerted on the one face represents the movement of the one face along an axis. Three sensors of the six sensors simultaneously detect three values of three forces exerted on three faces of the six faces when the touching cube is moved in the three simultaneous directions. The three values that are detected by the three sensors are provided to a microprocessor to analyze them relative to each other and determine the three-dimensional direction and value of the force.

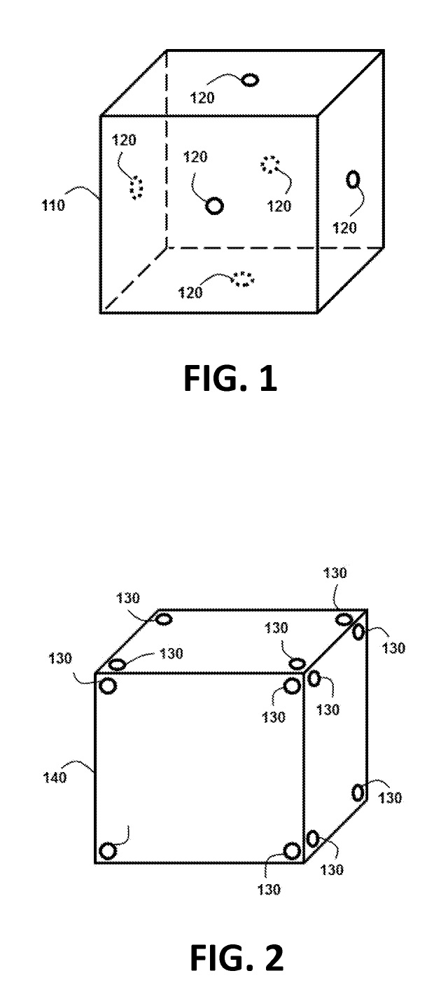

FIG. 1 illustrates an example of a touching cube 110 where a sensor 120 is attached to each face of the six faces of the touching cube. The touching cube can be moved slightly when a force is applied to any of its six faces. The sensors have fixed positions that do not move along with the movement of the touching cube. The movement of the touching cube applies a force to one, two, or three sensors of the six sensors. A force is applied to only one sensor when the touching cube is moved up or down, right or left, forward or backward. A force is simultaneously applied to two sensors when the touching cube is moved horizontally or vertically in a diagonal direction. A force is simultaneously applied to three sensors when the touching cube is moved in directions other than the aforementioned movements.

The shape of the touching cube, the number of the sensors, the positions of the sensors, and the type of sensors can come in different configuration than just the arrangement showed in FIG. 1. For example, FIG. 2 illustrates positioning four sensors 130, instead of one sensor on each face of the six faces of the cube 140. Each sensor of the four sensors is positioned near a corner on each of the four corners of a single cube face. Accordingly, each corner of the cube will have three sensors located on the three faces that meet at the corner. This manner of positioning the sensors at the cube corners allows for a more intuitive visual presentation for the user when using the present invention as a three-dimensional touchscreen, as disclosed in the U.S. patent application Ser. No. 14/169,822 which is assigned to the assignee of the present patent application.

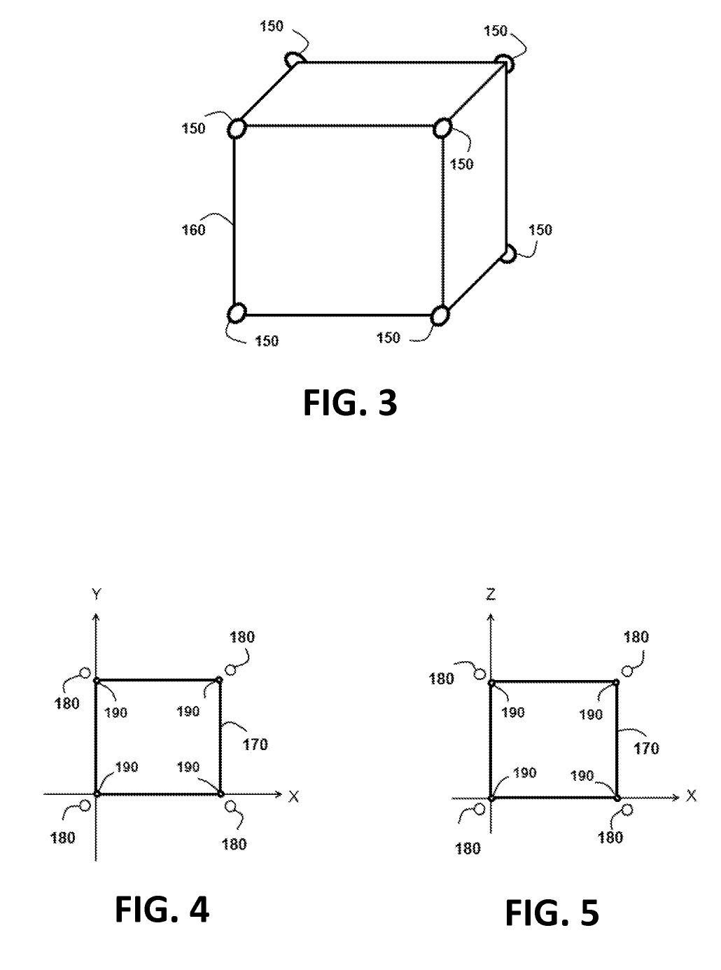

The three sensors positioned on three faces near a corner of the cube detect the movement of the three faces situated at the corner. However, the movement of the corner can represent the movement of the three faces that meet at the corner. Accordingly, the three sensors can be replaced by one sensor that detects the corner movement. For example, FIG. 3 illustrates a single sensor 150 positioned at each corner of a cube 160 to detect the movement of a cube corner. The movement of a cube corner can be analyzed to determine the corner movement relative to the x, y, and z-axis, which represent the movement of the three faces of the cube that meet at the corner. To do so, each sensor is positioned tilted or oblique relative to the x, y, and z-axis.

In one embodiment, the sensors used in FIG. 3 are optical sensors in the form of cameras, where each corner has a marker that is tracked by a camera. Accordingly, each camera is positioned away from a cube corner to capture the marker picture at this corner. FIG. 4 illustrates a top view of a cube 170 where four cameras 180 appear in this view to track the top four corners of the cube. FIG. 5 illustrates a front view of the cube 170 where four cameras 180 appear to track the front four corners of the cube. The markers 180 appear on each corner of the cube in front of the camera. As shown in the two figures, each camera is positioned away from a cube corner at a 45 degree angle relative to the x, y, and z-axis. The 45 degree angle ensures equal distances between the camera and the three faces that meet at the same cube corner.

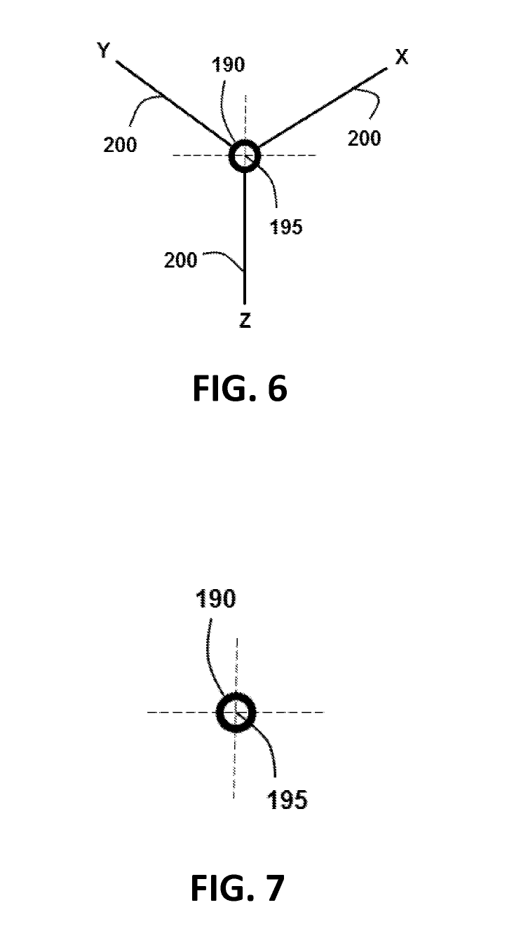

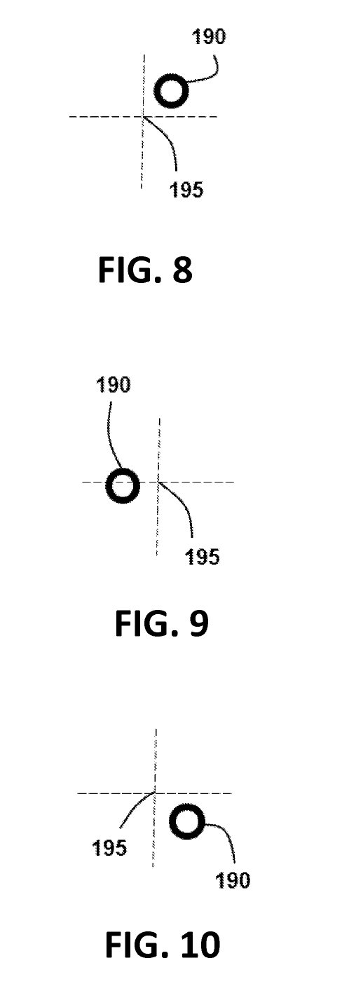

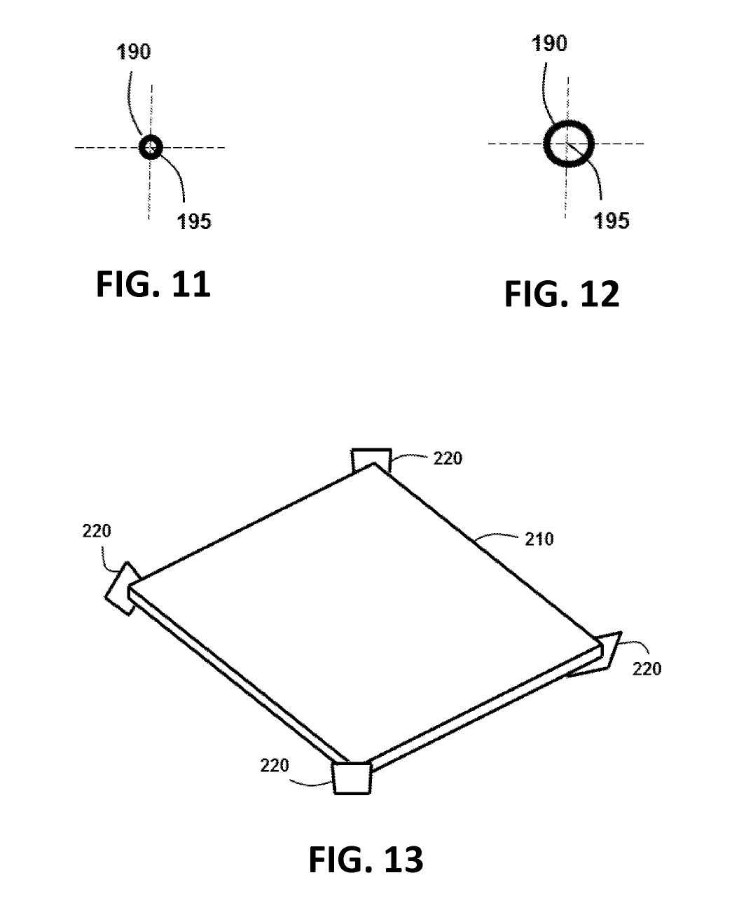

FIG. 6 illustrates the position of a corner marker 190 relative to the center of a camera 195, where three edges 200 of three faces of the cube parallel to the x, y, and z-axis are shown in the figure. FIG. 7 illustrates the same marker 190 relative the center of the camera 195 as they appear in the default position before moving the cube. FIGS. 8 to 10 illustrate three pictures taken of the marker that show the movement of the cube corner relative to the camera center. Analyzing the position of the marker relative to the center of the camera determines the movement of the cube relative to the x, y, and z-axis. FIGS. 11 and 12 illustrate two pictures taken where the maker size changes without changing its position relative to the x, y, and z-axis. This happens when the cube's corner is moved closer or further from the camera center, without changing the angles of the cube corner relative to the x, y, and z-axis.

In another embodiment, each camera at a corner is replaced with a force sensor attached to the corner to sense the partial force exerted from the corner on the force sensor as a result of the cube's movement. Analyzing the partial forces of each force sensor at a corner of the eight corners of the cube determines the cube movement relative to the x, y, and z-axis. Analyzing the cube movement relative to the x, y, and z-axis determines the magnitude and 3D tilting angle of the force applied to the cube. Moreover, the exact point of touch of the force can be determined, as described in the U.S. patent application Ser. No. 14/169,822.

The cube of the previous examples can take other forms that suit different applications. For example, when utilizing the touching cube to function as a touchscreen, the user only needs to touch one face of the six faces of the cube. Accordingly, replacing the cube with a panel is more practical for this situation, as a panel has a top surface that can be touched with the user's finger or stylus. FIG. 13 illustrates an example for this panel 210, where a force sensor 220 is positioned at each bottom corner of the panel. As shown in the figure, there are no force sensors positioned at the top corners of the panel, as no forces will be applied to the bottom surface or the edges of the panel. Accordingly, the four force sensors at the bottom corners of the panel are enough to determine the position of touch, the magnitude of the touch force, and the 3D tilting angle of the touch force relative to the top surface of the panel.

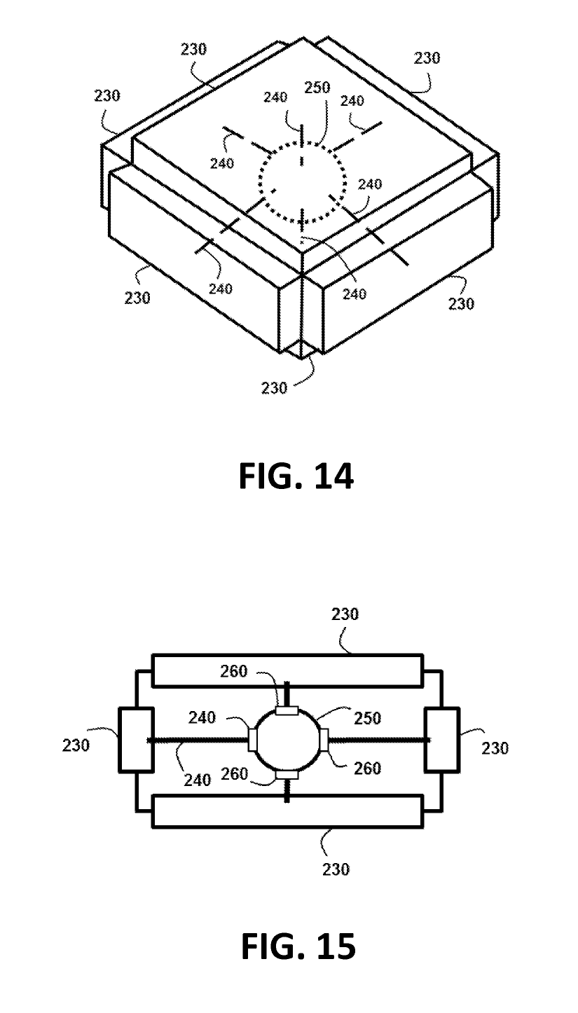

Generally, the previous description of the present invention of detecting the touch force and the 3D tilting angle of the touch force can be utilized in creating various forms of 3D force sensors. In one embodiment, the present invention discloses a 3D force sensor comprised of a chassis with six movable sides that apply a force to an interior sensing unit. The interior sensing unit measures the partial forces applied by the six sides on six force sensors. FIG. 14 illustrates an example of the aforementioned 3D force sensor. As shown in the figure, the 3D force sensor is comprised of a chassis comprised of six movable sides 230, where each movable side is connected to an arm 240 that moves with the movement of the movable side. A sphere 250 is located inside the chasses, where six force sensors are attached to the exterior surface of the sphere. When an arm is moved it presses on a force sensor to apply a force representing the distance of the arm movement. FIG. 15 illustrates a cross section of the 3D force sensors where the force sensors 260 appear between the sphere and the arms.

The 3D force sensor of the previous example detects the magnitude and 3D tilting angle of the force applied to any face of the six faces of the chassis. However, in the case of detecting a force applied only to one face, the number of the force sensors is reduced from six to four. These four force sensors are positioned at the four corners of the bottom side of a panel, as was described previously in FIG. 13.

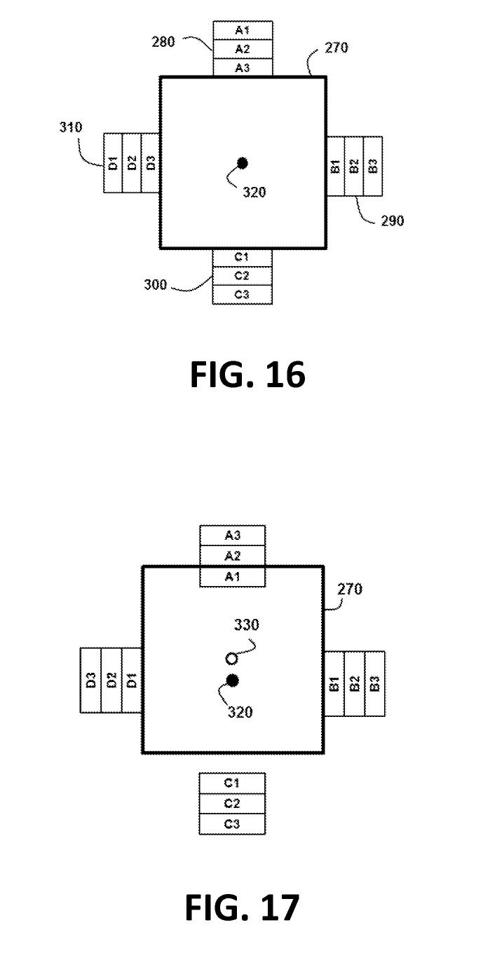

In another embodiment, the 3D force sensor utilizes ON/OFF buttons, instead of the force sensors of the previous examples, to detect the movement of a touching panel or a touching cube relative to the x, y, and z-axis. To clarify the concept of using the ON/OFF buttons, FIG. 16 illustrates a touch panel 270 that moves in the same direction of a force applied to the touch panel, parallel to the touch panel plane. A first plurality of buttons 280, a second plurality of buttons 290, a third plurality of buttons 300, and a fourth plurality of buttons 310 are located at the boundary of the touch panel, beneath the touch panel plane. The black circle 320 in the figure represents the center of the touching panel.

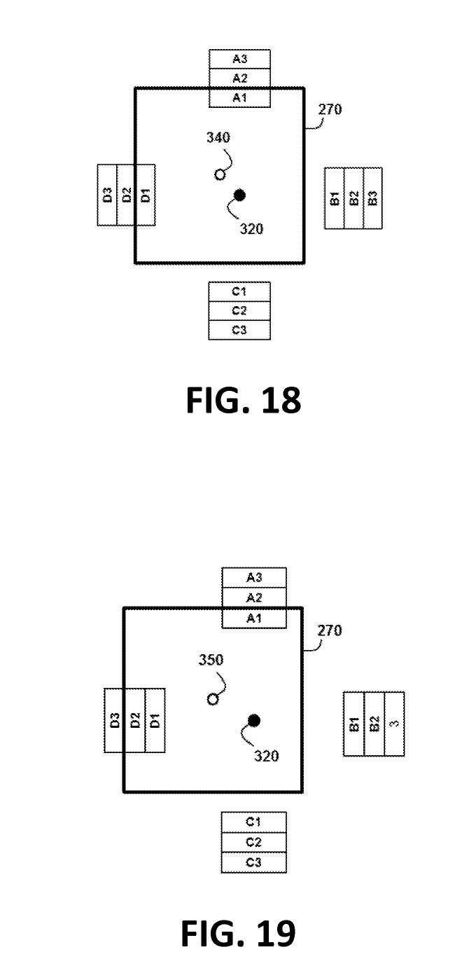

FIG. 17 illustrates moving the touching panel one step forward to touch the first button A1 of the first plurality of buttons. The white circle 330 in the figure represents the new location of the center of the touching panel relative to its default location, which is represented by the black circle 320. FIG. 18 illustrates moving the touching panel one step forward and one step to the left to touch respectively the first button A1 of the first plurality of buttons, and the first button D1 of the fourth plurality of buttons. The white circle 340 in the figure represents the new location of the center of the touching panel relative to its default location, which is represented by the black circle 320.

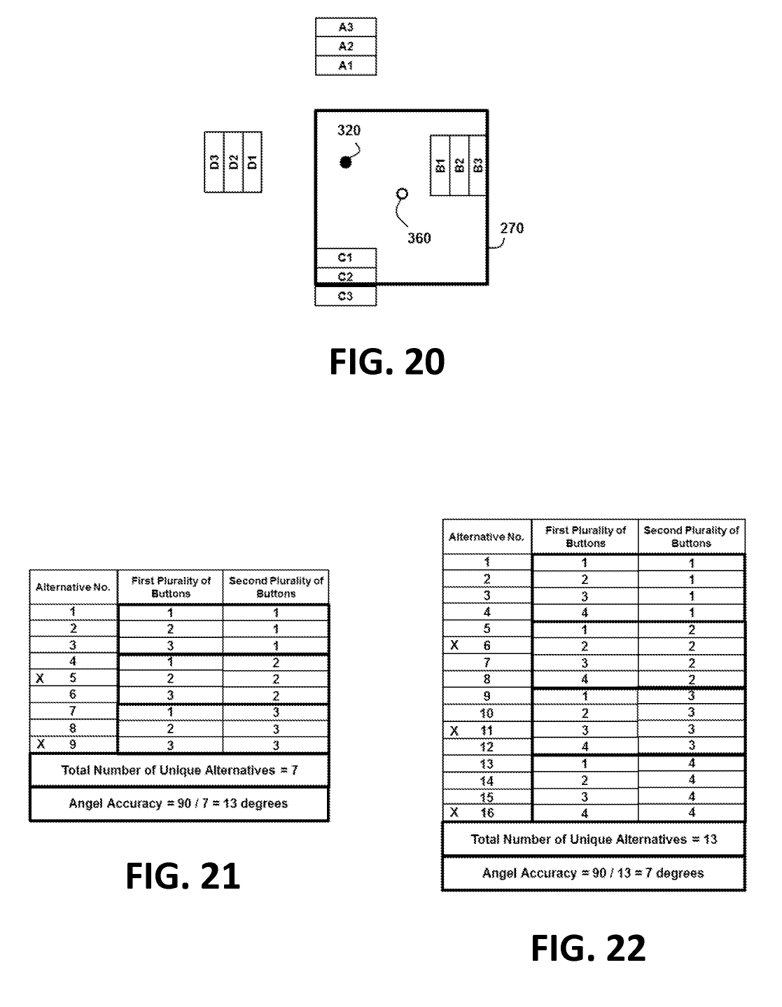

FIG. 19 illustrates moving the touching panel one step forward and two steps to the left to respectively touch the first button A1 of the first plurality of buttons, and the first and second buttons D1 and D2 of the fourth plurality of buttons. The white circle 350 in the figure represents the location of the center of the touching panel relative to its default location, which is represented by the black circle 320. FIG. 20 illustrates moving the touching panel three steps to the right and two steps backward to touch respectively the three buttons B1, B2, and B3 of the second plurality of buttons, and the first and second buttons C1 and C2 of the third plurality of buttons. The white circle 360 in the figure represents the location of the center of the touching panel relative to its default location, which is represented by the black circle 320.

Analyzing which buttons are touched and which buttons are untouched determines the movement of the touching panel relative to the x-axis and the y-axis. The ratio between the movements of the touching panel along the x-axis and the y-axis determines the direction of the touch force. Accordingly, the direction of the touching force of FIGS. 17 to 20 respectively is 90, 145, −34, and 153 relative to the positive x-axis.

In one embodiment, the buttons of each plurality of buttons are ON/OFF buttons that are turned ON when they are touched by the touching panel. The number of the buttons used in each plurality of buttons may vary, where using more buttons leads to greater accuracy in detecting the exact direction or angle of the touching panel movement. For example, the table of FIG. 21 shows the number of direction alternatives of a touch panel which utilizes three ON/OFF buttons in each plurality of the four pluralities of buttons. The table indicates the first and second plurality of buttons that represent the direction of the touching panel's movement between zero and 90 degrees. As shown in the table, there are seven unique alternatives or combinations of touched buttons, numbers 1-4 and 6-8. The alternatives numbers 5 and 9 are similar to the alternative number 1, which represents the 45 degree angle of the touching panel movement. That leads to an accuracy of around 13 degrees. In other words, using three buttons in each plurality of buttons, will approximate the detection of the angles of the touching panel movement to 0, 13, 26, 39, 52 degrees and so on.

FIG. 22 illustrates a table indicating the use of four buttons, in each plurality of buttons. As shown in the table, the number of the unique alternatives of angles is 13. The alternatives numbers 6, 11, and 16 are similar to the alternative number 1, where all of them represent the 45 degree angle of the touching panel movement. Accordingly, the accuracy of detecting the angle of the touching panel movement is 7 degrees, which is a result of dividing 90 degrees by 13 alternatives. Of course, using a larger number of ON/OFF buttons leads to an increased accuracy in detecting the movement direction of the touching panel.

In another embodiment, each one of the ON/OFF button is a force sensor. For example, in FIG. 16 each one of the ON/OFF button will be replaced with a force sensor. Accordingly, the number of the touched buttons will determine the direction of the touch force along the touching panel plane, while the magnitude of the partial forces applied to the touched force sensors will determine the orthogonal force to the touching panel plane, in addition to, the location of the point of touch. It is important to note that, the movement of the touching panel relative to the x and y-axis also represents the magnitude of the touch force parallel to the touching panel plane. Accordingly, the 3D tilting angle or direction of the touch force can be determined by finding the ratio between the parallel force to the touching panel plane and the orthogonal force to the touching panel plane.

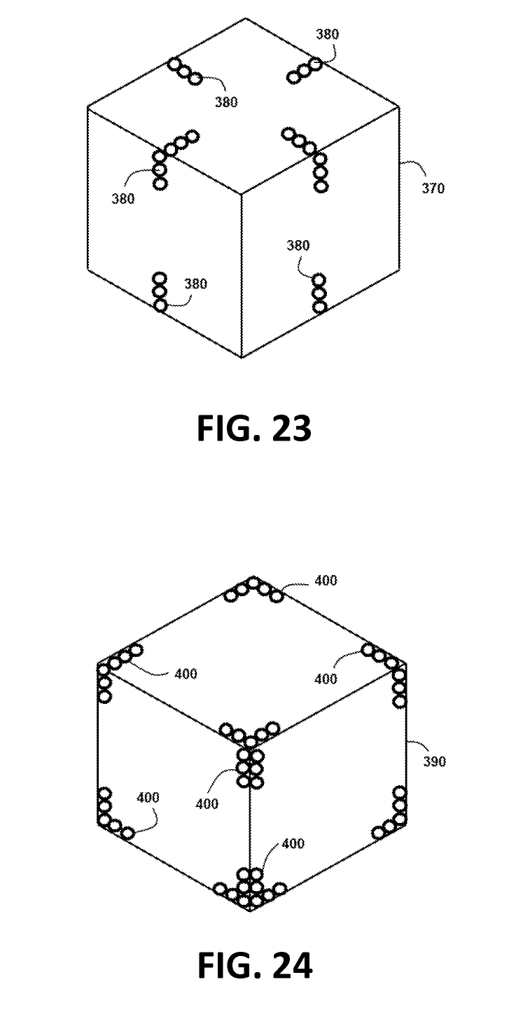

Generally, using the force sensors to replace the ON/OFF buttons enables detection of the point of touch, and the magnitude and 3D tilting direction of a force applied to a surface from one side. To detect the point of touch, and the magnitude and 3D direction of a force applied to a cube from one or more sides, the idea of the ON/OFF buttons is utilized in three dimensions. For example, FIG. 23 illustrates a touching cube 370 where three sensors 380 are positioned on each side of a face of the touching cube. The three sensors can be ON/OFF buttons or force sensors. Also, the number of the sensors may vary from three sensors.

FIG. 24 illustrates another touching cube 390 where force sensors 400 are positioned at the corners of the touching cube to make the centers areas of the touching cube's faces suitable for presenting digital data. In this case too, the sensors can be ON/OFF buttons or force sensors, as previously described. However, whether using either ON/OFF buttons or force sensors, the present invention detects the movement of the touching cube along the x, y, and z-axis. Detection of the touching cube's movement along the x, y, and z-axis determines the point of touch, and the magnitude and 3D tilting angle of the force applied to any face of the touching cube.

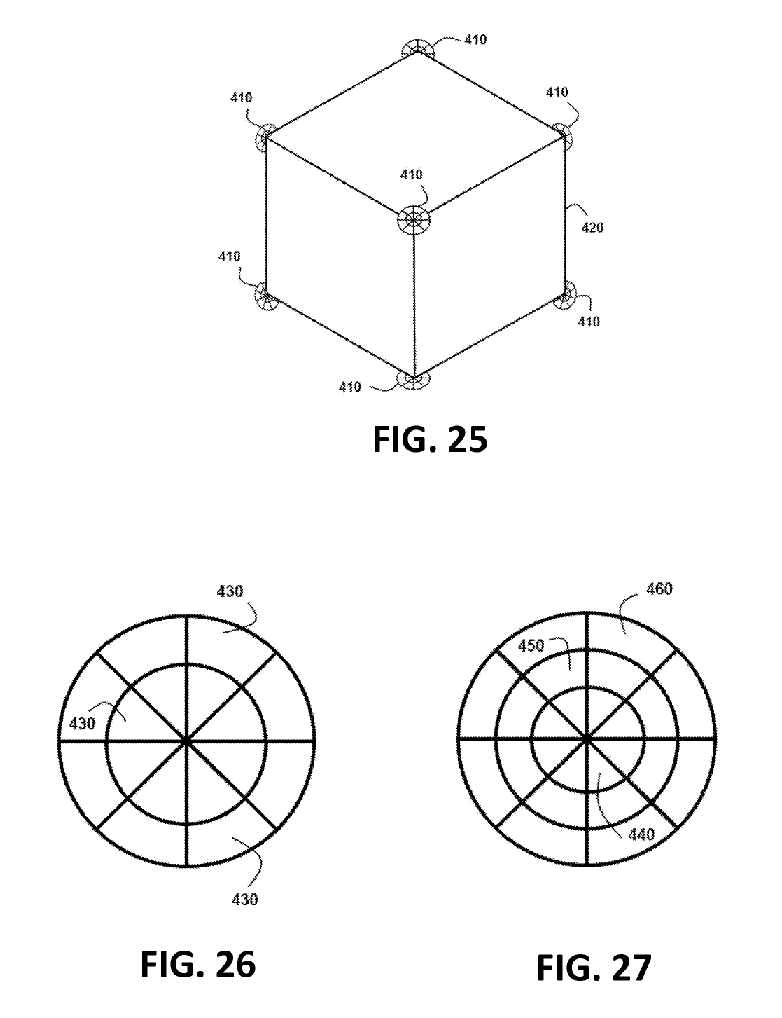

FIG. 25 illustrates positioning a plurality of sensors at each corner of the touching cube, similar to the concept of FIG. 3. The main difference in FIG. 25 is the use of a plurality of sensors instead of just one sensor. The plurality of sensors is positioned tilted or oblique relative to the three faces of the cube that meet at the same corner. FIG. 26 illustrates the plurality of sensors used in FIG. 25. As shown in the figure, the sensors are positioned in two circular layers, where each layer includes six sensors 430. FIG. 27 illustrates another plurality of sensors where there are three circular layers of sensors 440-460. The function of the circular layer is to allow interaction with the cube corner when it is moved in any direction. However, each of the sensors positioned in the circular layers can be an ON/OFF button or force sensor. There can be more than three layers of sensors. In this case, the plane of the circular layers is positioned at 45 degrees relative to the three faces of the cube that meet at the same corner.

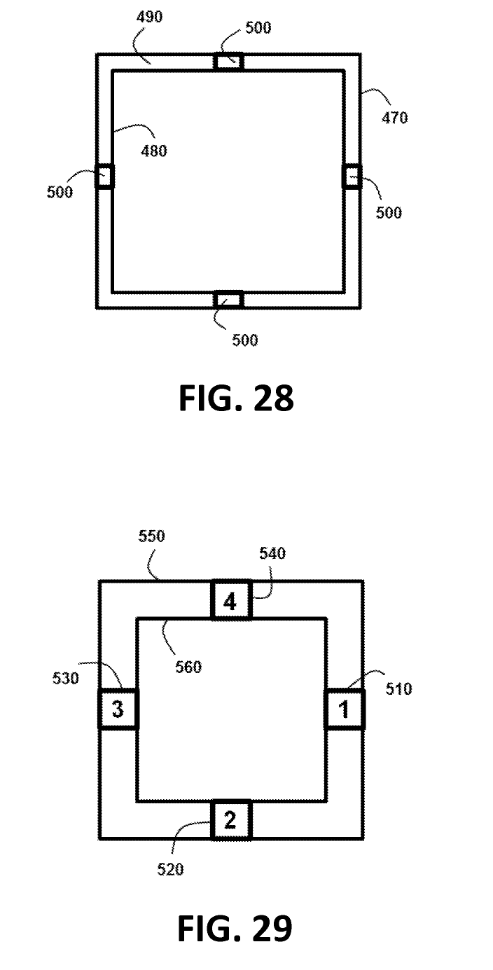

FIG. 28 illustrates the configuration used in layering of the 3D force sensors of the present invention. As shown in the figure, an exterior surface 470 can be touched by a user's finger or stylus to move in the same direction of the force applied by the user's finger or stylus. The figure shows an interior surface 480 located inside the exterior surface. The interior surface does not move with the movement of the exterior surface. Also, the figure illustrates an intermediate zone 490, which is located between the exterior surface and the interior surface. The intermediate zone includes a plurality of sensors 500, and where one or more sensors of the plurality of sensors are pressed by the exterior surface when it is moved in any direction.

The plurality of sensors can be positioned in different locations on the interior surface. For example, they can be positioned at the center of each face of the interior surface, or they can be positioned at the corners of each face of the interior surface. The number of sensors may vary, as was described previously. The shape of the exterior and interior surface can be cubical, spherical, cylindrical, or panel shaped. The type of sensors can be ON/OFF buttons, force sensors, optical sensors or cameras, as was described previously.

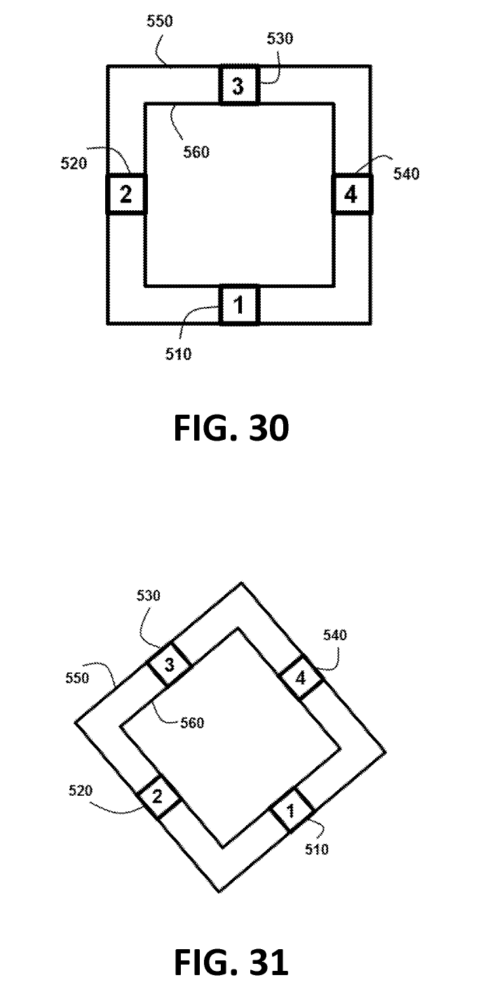

The interior surface of the 3D force sensor has a weight that exerts a force on the bottom sensors of the 3D force sensor. Each different rotation of the 3D force sensor causes the weight of the interior surface to apply a force to different sensors of the 3D force sensor. For example, FIG. 29 illustrates a first sensor 510, a second sensor 520, a third sensor 530, and a fourth sensor 540 located between an exterior surface 550 and an interior surface 560 of a 3D force sensor. As shown in the figure, the second sensor senses the weight of the interior surface. FIG. 30 illustrates rotating the 3D force sensor where the first sensor senses the weight of the interior surface. FIG. 31 illustrates rotating the 3D force sensor in a diagonal position where the first and second sensors sense the weight of the interior surface.

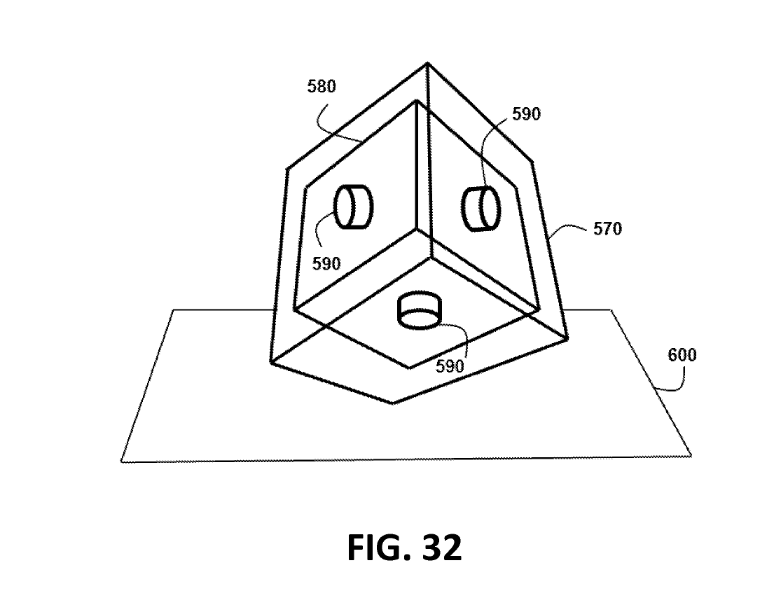

FIG. 32 illustrates an example of a 3D force sensor in the form of a cube. The 3D force sensor is comprised of an exterior surface 570 in the form of a cube, an interior surface 580 in the form of a cube, and six force sensors 590, each of which is located on a face of the six faces of the interior surface cube. As shown in the figure, the 3D force sensor is positioned on one of its corner, on a surface 600. In this case, three force sensors of the six force sensors sense the weight of the interior surface. Comparing the force applied by the interior surface on the three force sensors determines the tilting angle of the 3D force sensor relative to the xy-plane.

Generally, detecting the rotation or tilting of the present invention of the 3D force sensor can be utilized in various innovative hardware. For example, in one embodiment, the 3D force sensor is equipped with a wireless connection that generates a wireless signal, indicating the force applied on each force sensor by the interior surface or the exterior surface. The forces applied to the force sensors by the interior surface determine the 3D tilting angle of the 3D force sensor relative to the xy-plane. The forces applied to the force sensors by the exterior surface determine the point of touch, the magnitude and 3D tilting angle of the exterior force applied to the exterior surface. This concept of utilizing the present invention serves a variety of innovative applications for the Internet of things.

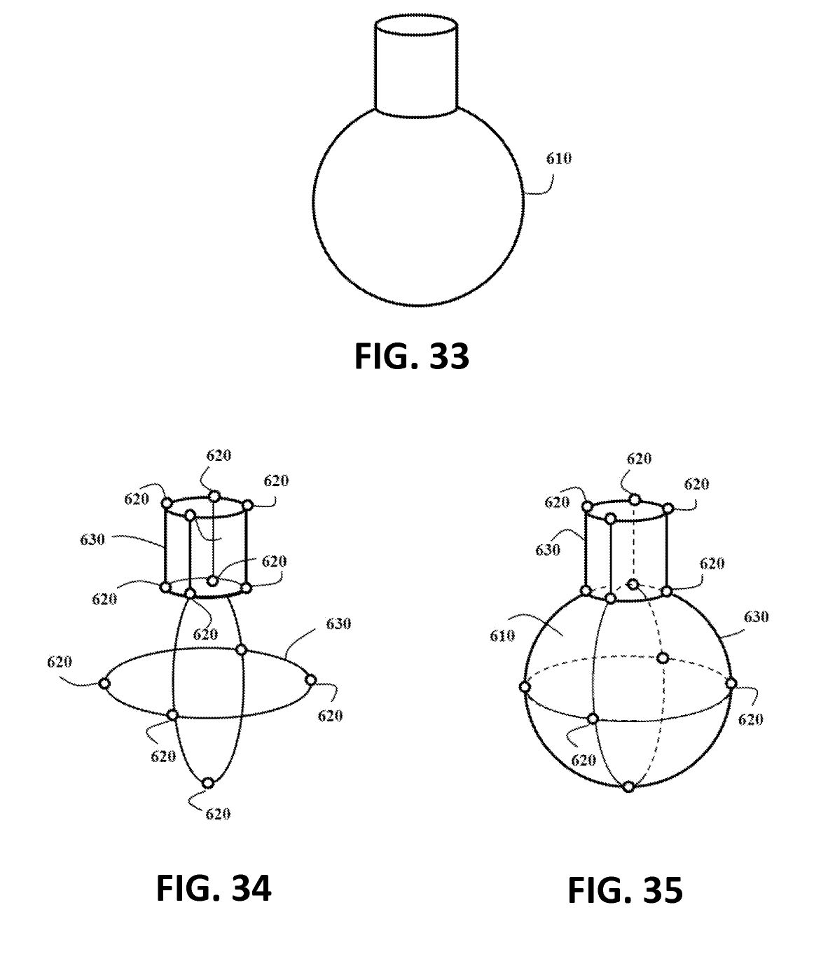

For example, FIG. 33 illustrates a vase 610. FIG. 34 illustrates a plurality of 3D force sensors 620, each of which is attached to a wireframe 630 that simulates the exterior of the vase. FIG. 35 illustrates positioning the vase inside the wireframe where the 3D force sensors come in contact with the vase. At this moment, touching the vase with a user's finger applies a force to the vase that is transformed to the 3D force sensors. Analyzing the forces applied to the 3D force sensors determines the point of touch, the magnitude and 3D tilting angle of the user's finger at the moment of touch. If the vase is tilted relative to its vertical position, the 3D force sensors are consequently tilted. At this moment, each 3D force sensor detects its tilting, which determines the 3D tilting angle of the vase.

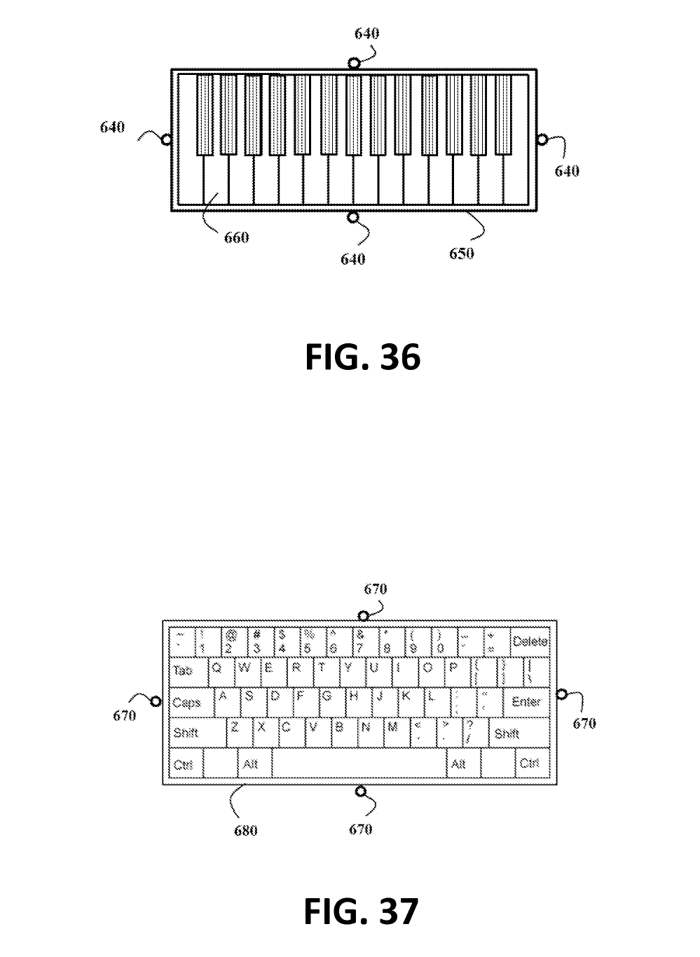

FIG. 36 illustrates using a plurality of 3D force sensors 640 with a wireframe 650 to be attached to a piano keyboard imitator 660. The piano keyboard imitator can be a printed picture of the piano keyboard positioned on a piece of wood, plastic, or the like. In this case, the touch point of the piano keyboard imitator is determined to generate, in real time, a musical sound corresponding to the touch point of the piano keyboard. The magnitude of the force applied by the user's fingers to the piano keyboard imitator determines the volume of the musical sound. The musical sounds can be generated by an electronic device such as a computer, tablet, or mobile phone which receives the wireless signals of the 3D force sensors and translate them into corresponding musical sounds.

FIG. 37 illustrates using the same concept with a computer keyboard, where a plurality of 3D force sensors 670 is attached along with a wireframe to a computer keyboard 680. In this case, the point of touch on the computer keyboard is determined, as well as, the magnitude and 3D tilting angle of the force applied by user's finger at the moment of touch. The magnitude and 3D tilting angle of the force can be utilized in various 3D gaming applications, 3D modeling applications, or graphics applications, as was mentioned previously. This enables the computer keyboard to provide the user with additional interactions for complex computer applications, without the need for using a computer mouse, or an expensive 3D input device.

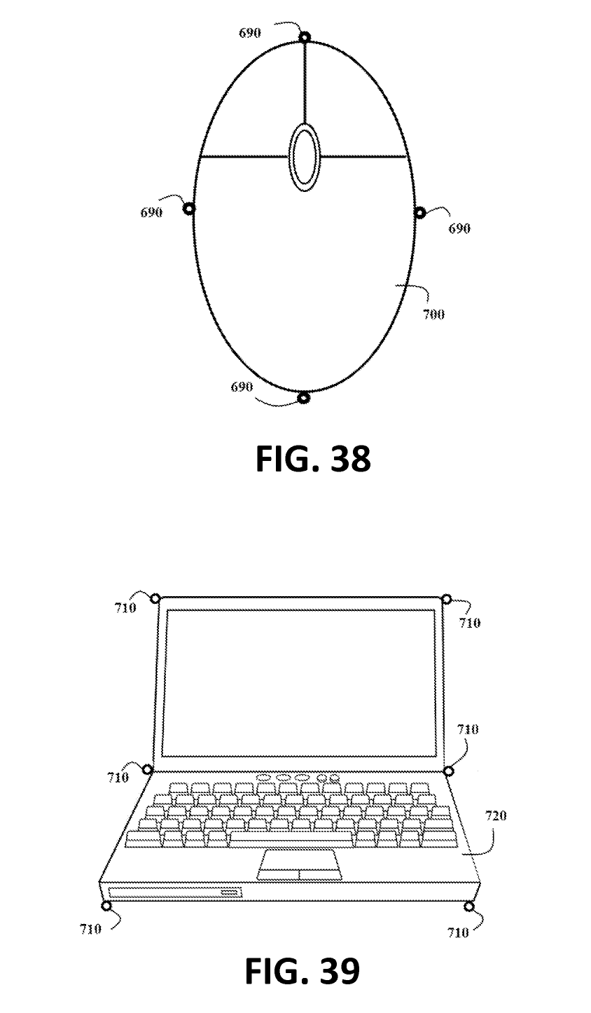

FIG. 38 illustrates using a plurality of 3D force sensors 690 with a wireframe which is attached to a computer mouse 700 to detect the point of touch, the magnitude and 3D tilting angle of the user's finger when touching any point on the computer mouse. In this case, the surface of the computer mouse is converted into a touchpad, and the computer mouse can function as a 3D input device capable of interaction with complex 3D gaming applications. FIG. 39 illustrates using a plurality of 3D force sensors 710 with a wireframe attached to a laptop computer 720. This way, the screen of the laptop can function as a touchscreen where it detects the touch location of the user's finger or stylus. Also, all other parts of the laptop, including the laptop case and the computer keyboard, can function as a touchpad.

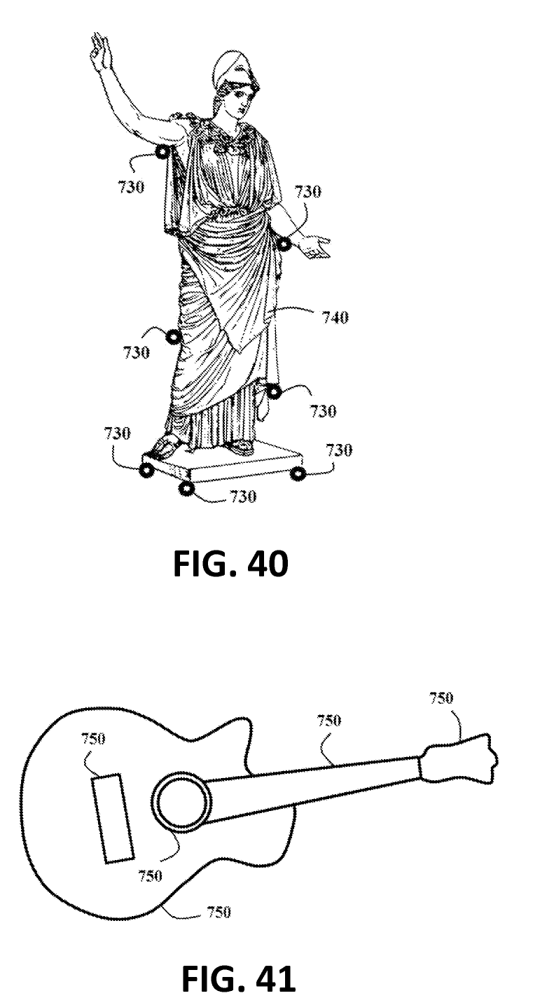

FIG. 40 illustrates using the present invention of the 3D force sensors 730 and wireframe with a statue 740. FIG. 41 illustrates using the present invention with a guitar imitator. The same concept can be used to detect the magnitude and 3D direction of air blown when interacting with a nonfunctioning trumpet replication, where corresponding musical sounds are generated via an additional device. The additional device can be a computer, tablet, or mobile phone that acts as speakers which receive the wireless signals of the 3D force sensors and translate these signals into corresponding musical sounds abiding to the true musical nature of the desired musical instrument.

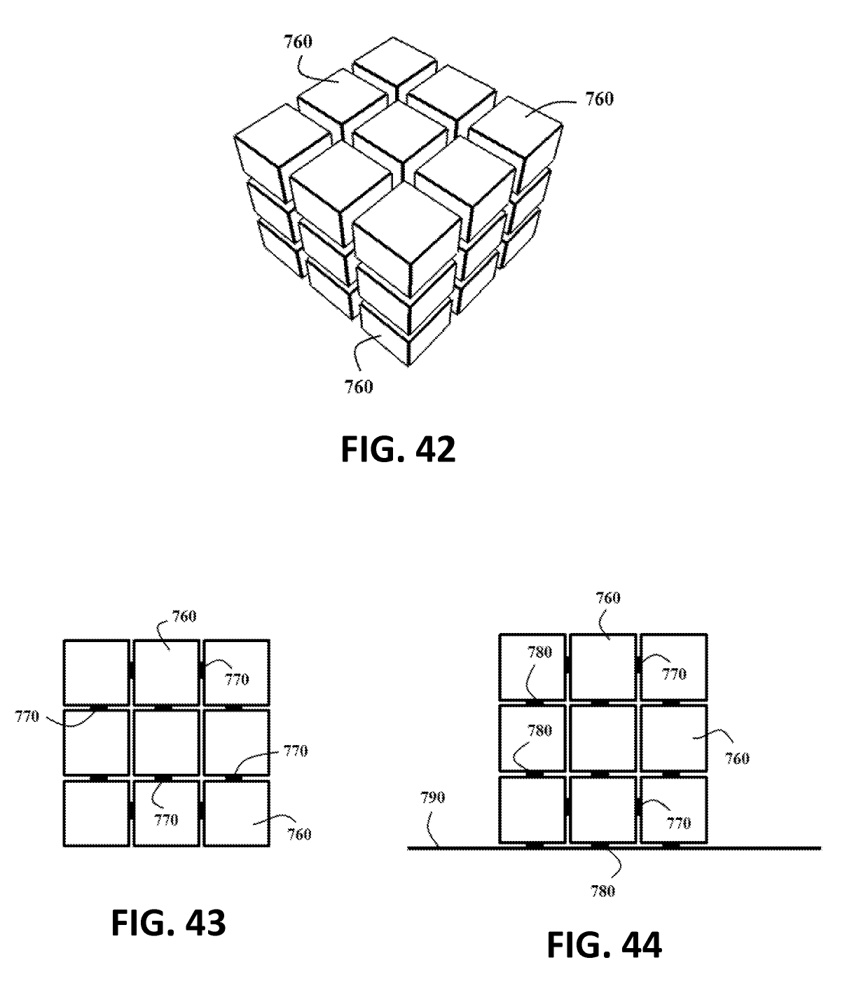

FIG. 42 illustrates another application that utilizes the 3D force sensors, without the need for a wireframe to hold the force sensors. As shown in the figure, a plurality of objects or boxes 760 is stacked vertically on top of each other. FIG. 43 illustrates a top view of the boxes 760 where a first plurality of the 3D force sensors 770 is positioned vertically between the boxes columns. FIG. 44 illustrates a front view of the boxes 760 where a second plurality of the 3D force sensors 770 is positioned horizontally between the boxes rows. The boxes columns are positioned on the ground 790, as illustrated in the front view.

In this case, each one of the first plurality of the 3D force sensors detects the attachment between two successive boxes located in two different columns. Once the two successive boxes are moved away from each other, the force applied to the 3D force sensor is released. Also, each one of the second plurality of the 3D force sensors detects the vertical alignment of two boxes located in the same column. Once the two boxes are shifted relative to each other, the 3D force sensors sense this shift. Each 3D force sensor generates a wireless signal representing its ID and the force applied to it. A CPU receives the wireless signals of the 3D force sensors and analyzes them to simulate the current positions of the boxes or objects relative to each other on a computer display.

Generally, the aforementioned utilization of the present invention serves the future evolution of the Internet of Things by providing additional information about the change of the shapes, or positions of tracked objects, relative to each other. This includes objects that have fixed positions, such as the buildings walls, floors, roofs and structural elements. It also includes objects that can be moved from one position to another such, as furniture, electronic devices, mechanical parts, or the like.

The main advantages of the present invention is utilizing an existing hardware technology that is simple and straightforward which easily and inexpensively carry out the present 3D force sensors. For example, the force sensors used in the 3D force sensors of the present invention are traditional force sensors that are positioned below the touching cube or the touching surface within a medium that transfers contact force throughout the sensor area. They can be a piezoelectric sensor, capacitive sensor, resistive sensor, or the like. The piezoelectric sensor can have one of a bendable piezoelectric stack and a compressible piezoelectric stack. Also, the force sensor can have a first capacitive plate, a second capacitive plate, and a compressible elastomeric dielectric material positioned between the first capacitive plate and the second capacitive plate. The sensor signal that is processed can be an analog signal, such as a voltage, capacitance charge, frequency, or the like. The analog processing can be performed on a voltage output of Force Sensitive Resistor (FSR) type sensors. The processing can also be performed on a charge from a pieZo-ceramic material, such as a pieZoelectric transducer.

The optical sensor that senses the movement of the cube corner in FIGS. 4 to 12, can be one or more light emitting diodes (LEDs) and an imaging array of photodiodes to detect the movement of the cube corner relative to a default position. It can also use coherent laser light, similar to the way of using optical or laser sensors to track the movement of the computer mouse on a surface. The ON/OFF buttons used in FIGS. 16 to 20 are traditional switches that connect or disconnect two points in a circuit when the button is touched or pressed.

The processing of the signals or data collected from the sensors of the present invention is implemented on a programmed processor. It can also be implemented on a special purpose computer, a programmed microprocessor or microcontroller and peripheral integrated circuit elements, an integrated circuit, or logic circuit such as a discrete element circuit, or a programmable logic device. It can also be implemented on a mobile phone, tablet, or laptop computer that receives the wireless signals of the 3D force sensors.

Overall, as discussed above, a 3D force sensor is disclosed, while a number of exemplary aspects and embodiments have been discussed above, those skilled in the art will recognize certain modifications, permutations, additions and sub-combinations thereof. It is therefore intended that claims hereafter introduced are interpreted to include all such modifications, permutations, additions and sub-combinations as are within their true spirit and scope.

1. A 3D force sensor to detect the 3D direction of a contact force that can be non-parallel and non-orthogonal to the 3D force sensor surface and the 3D force sensors is comprised of;
an exterior housing to be in touch with the contact force;
an interior housing located inside the exterior housing;
a plurality of sensors located between the exterior housing and the interior housing to track the movement of each corner of the exterior housing relative to the x, y, and z-axis due to the contact force, and generate a signal representing the movement; and
a microprocessor that receives the signals of the plurality of sensors and determines the 3D direction of the contact force.

2. The 3D force sensor of claim 1 wherein the plurality of sensors are optical sensors that track the corners movement relative to the x, y, and z-axis.

3. The 3D force sensor of claim 1 wherein the plurality of sensors are force sensors positioned to be oblige to the surfaces of the exterior housing at each corner.

4. The 3D force sensor of claim 1 wherein each sensor of the plurality of sensors is a plurality of ON/OFF buttons.

5. The 3D force sensor of claim 1 wherein both of the exterior housing and the interior housing are in the form of a cube, sphere, or other three-dimensional shapes.

6. The 3D force sensor of claim 1 wherein both of the exterior housing and the interior housing are in the form of a panel.

7. The 3D force sensor of claim 2 wherein the optical sensors are cameras that capture the pictures of the corners movement.

8. A 3D force sensor that can be tilted relative to the xy-plane due to a contact force wherein the 3D force sensor detects the 3D angle of the tilting and the 3D direction of the contact force, and the 3D force sensors is comprised of an exterior housing to be in touch with the contact force;
an interior housing which is located inside the exterior housing;
a plurality of sensors located between the exterior housing and the interior housing to detect a first force applied by the weight of the interior housing and a second force applied by the contact force, and generate signals representing the first force and the second force; and
a microprocessor that receives the signals and determines the 3D angle of the tilting and the 3D direction of the contact force.

9. The 3D force sensor of claim 8 wherein each sensor of the plurality of sensors is one or more force sensors.

10. The 3D force sensor of claim 8 wherein the plurality of sensors are force sensors positioned to be oblige to the surfaces or faces of the exterior housing that meet at the same corner.

11. The 3D force sensor of claim 8 wherein each sensor of the plurality of sensors is a plurality of ON/OFF buttons.

12. The 3D force sensor of claim 8 further a plurality of the 3D force sensors simultaneously used with different parts of a single object.

13. The 3D force sensor of claim 8 further a plurality of the 3D force sensors simultaneously used with a plurality of objects that are stacked vertically or horizontally relative to each other.

14. The 3D force sensor of claim 10 wherein the plurality of sensors is configured to form a circular area divided into circular strips.

15. A 3D force sensing system to determine the point of touch, the magnitude, and the 3D direction of a touch force applied to a 3D object, wherein the 3D force sensing system is comprised of;
a wireframe to be positioned on the 3D object to allow the 3D object to be touched by the touch force;
a plurality of sensing units attached to the wireframe to be pressed by the 3D object when the 3D object is touched by the object;
a microprocessor that receives the signals of the plurality of sensing units to determine the point of touch, the magnitude, and the 3D direction.

16. The 3D force sensing system of claim 15 further the microprocessor determines the 3D tilting angle of the 3D object relative to the xy-plane.

17. The 3D force sensing system of claim 15 wherein each sensor of the plurality of sensing unit is positioned to be parallel to a spot of the 3D object.

18. The 3D force sensing system of claim 15 wherein the 3D object is a computer keyboard, computer mouse, computer, or an electronic device.

19. The 3D force sensing system of claim 15 further the 3D object is a musical instrument imitator, and each point of touch is associated with a corresponding musical sound generated by an electronic device.

20. The 3D force sensing system of claim 15 further the shape of the 3D object and the position of the point of touch are simulated in real time on a computer display.
